(19) United States
(12) Patent Application Publication
(10) Pub. No.: US 2020/0123642 A1
(43) Pub. Date: Apr. 23, 2020

(54) PLASMA SPRAY PHYSICAL VAPOR DEPOSITION WITHIN INTERNAL CAVITY

(71) Applicants: Rolls-Royce North American Technologies, Inc., Indianapolis, IN (US); Rolls-Royce Corporation, Indianapolis, IN (US)

(72) Inventors: Matthew R. Gold, Carmel, IN (US); Ann Bolcavage, Indianapolis, IN (US)

(73) Assignees: Rolls-Royce North American Technologies, Inc.; Rolls-Royce Corporation

(21) Appl. No.: 16/656,291

(22) Filed: Oct. 17, 2019

Related U.S. Application Data
(60) Provisional application No. 62/747,524, filed on Oct. 18, 2018.

(51) Int. Cl. C23C 4/134; C23C 4/10; F01D 5/28

(52) U.S. Cl. CPC C23C 4/134; C23C 4/10; F05D 2300/6033; F01D 5/288; F05D 2300/15; F01D 5/284

(57) ABSTRACT

In some examples, a plasma spray physical vapor deposition system includes a vacuum pump; a vacuum chamber; a coating material source; a plasma spray device configured to generate a plasma plume including vaporized coating material; and a funnel. The funnel has an inlet opening and an outlet opening smaller than the inlet opening. The funnel is configured and positioned to receive the plasma plume through the inlet opening and direct the plasma plume out of the outlet opening.

This application claims the benefit of U.S. Provisional Application No. 62/747,524, filed Oct. 18, 2018, which is incorporated herein by reference in its entirety.

### TECHNICAL FIELD

The disclosure relates to plasma spray physical vapor deposition.

### BACKGROUND

Ceramic or ceramic matrix composite (CMC) materials may be useful in a variety of contexts where mechanical and thermal properties are important. For example, components of high temperature mechanical systems, such as gas turbine engines, may be made from ceramic or CMC materials. Ceramic or CMC materials may be resistant to high temperatures, but some ceramic or CMC materials may react with some elements and compounds present in the operating environment of high temperature mechanical systems, such as water vapor. Reaction with water vapor may result in the recession of the ceramic or CMC material. These reactions may damage the ceramic or CMC material and reduce mechanical properties of the ceramic or CMC material, which may reduce the useful lifetime of the component. Thus, in some examples, a ceramic or CMC material may be coated with an environmental barrier coating, which may reduce exposure of the substrate to elements and compounds present in the operating environment of high temperature mechanical systems.

### SUMMARY

In some examples, the disclosure describes systems and techniques for forming a coating on a component using plasma spray physical vapor deposition (PS PVD). For example, the systems and techniques described in the disclosure may be employed to form a coating, such as an environmental and/or thermal barrier coating, on the surface of an internal cavity of a component using PS PVD. To form the coating on the surface of an internal cavity, a PS PVD system may include a funnel that is configured to direct a plasma plume generated by a plasma spray device (e.g., a plasma spray gun) into an opening of the internal cavity of the component. In this manner, a vaporized coating material in the plasma plume directed into the internal cavity by the funnel may form a coating on the surface(s) of the internal cavity. In some cases, the funnel may reduce the width of the plasma plume generated by the plasma spray device to a width that is substantially the same or less than the size of the opening of the internal cavity of the component.

In some examples, the disclosure describes a plasma spray physical vapor deposition system that includes a vacuum pump; a vacuum chamber; a coating material source; a plasma spray device configured to generate a plasma plume including vaporized coating material; and a funnel having an inlet opening and an outlet opening smaller than the inlet opening, wherein the funnel is configured and positioned to receive the plasma plume through the inlet opening and direct the plasma plume out of the outlet opening.

In some examples, the disclosure describes a method for forming a coating using plasma spray physical vapor deposition. The method includes generating a plasma plume via a plasma spray device, wherein the plasma plume includes vaporized coating material, and positioning a funnel having an inlet opening and a smaller outlet opening relative to the plasma spray device such that the plasma plume enters through the inlet opening and is directed by the funnel out of the outlet opening.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic diagram illustrating an example system for forming an environmental barrier coating using plasma spray physical vapor deposition.

FIGS. 2 and 3 are conceptual and schematic diagrams illustrating a portion of the system of FIG. 1.

FIG. 4 is a conceptual diagram illustrating a plan view of an outlet opening of a funnel from the “bottom” of the funnel in the orientation show in FIG. 2.

FIG. 5 is a conceptual diagram illustrating a plan view of an inlet opening of a funnel from the “top” of the funnel in the orientation show in FIG. 2.

FIG. 6 is a conceptual diagram illustrating a cross sectional view of a substrate taken along cross-section A-A shown in FIG. 2 prior to the formation of a coating on the surface of an internal cavity defined by the substrate.

FIG. 7 is a conceptual diagram illustrating a cross sectional view of a substrate taken along cross-section A-A shown in FIG. 2 after the formation of a coating on the surface of an internal cavity defined by the substrate.

FIG. 8 is a flow diagram illustrating an example technique for forming a coating on the surface of an internal cavity using the system of FIG. 1.

FIG. 9 is a photograph of an example funnel of a PS PVD system and a tubular substrate having an internal cavity.

FIGS. 10A-10D are schematic diagrams illustrating various aspects of the tubular substrate shown in FIG. 9.

FIG. 11 is a photograph illustrating the operation of a PS PVD system including the funnel and tubular substrate shown in FIG. 9.

FIG. 12 is a conceptual diagram illustrating the funnel and tubular substrate of FIG. 9 with reference markers along the length of the tubular substrate.

FIGS. 13-17 are cross-sectional micrographs of an example coating deposited using PS PVD at the various reference points indicated in FIG. 12.

FIG. 18 is a plot of coating thickness versus position within the internal cavity for the tubular substrate shown in FIG. 9.

### DETAILED DESCRIPTION

The disclosure describes, in some examples, systems and techniques for forming a coating on a component using plasma spray physical vapor deposition (PS PVD). Example coatings that may be formed include environmental barrier coatings (EBCs) and thermal barrier coatings (TBCs). The components may be made from ceramic, CMC, superalloy, or other material. As described herein, a PS PVD system may employ a funnel that directs a generated plasma plume into an internal cavity of a component to form a coating on the surface of the internal cavity.

A PS PVD process may be employed to form one or more layers on components used for a variety of applications, such as components of gas turbine engines or other high temperature mechanical systems. In the context of gas turbine engines, increasing demands for greater operating efficiency (e.g., fuel efficiency) has led to the operation of gas turbine engines at higher temperatures. Components of the gas turbine engines, such as a blade or a vane, may be made from ceramic or CMC substrates. In some examples, substrates of high-temperature mechanical systems are coated with an EBC using a PS PVD process to provide environmental protection for the underlying substrate material(s) in a high temperature environment. Additionally, or alternatively, substrates of high-temperature mechanical systems may be coated with a TBC to provide thermal protection to the underlying substrate, e.g., by reducing heat transfer from the external environment to the substrate.

PS PVD may be carried out in a high vacuum, inert atmosphere and may include generating a plasma plume which carries the vapor phase of a powder feedstock within the highly energetic gas. While PS PVD may be used to form coatings on line of sight surfaces of a component, in some cases, a component with complex geometry may have non-line of sight surfaces that are desirable to coat, e.g., with an EBC or other coating, using PS-PVD. In some examples, a component may have one or more internal surfaces on which it is desirable to form a TBC, EBC and/or other coating. For example, a ceramic or CMC vane of a gas turbine engine may be hollow such that the component defines an internal cavity. It may be desirable to form an EBC and/or TBC coating on the surface of the internal cavity of the vane. However, the geometry of such a component presents a challenge in coating such internal surfaces, e.g., as compared to coating the outer surface of such a component, particularly using a PS-PVD process. One challenge of coating the surface of an internal cavity with a PS-PVD process is directing the energetic gas of the plasma plume containing the coating material in a vapor phase into the internal cavity, e.g., through the center or other opening of the component into the internal cavity.

In accordance with some examples of the disclosure, a PS PVD process may be employed in which a funnel directs the plasma plume generated by a plasma spray device into an internal cavity of a component. As noted above, the plasma plume generated by the plasma spray device includes highly energetic gas carrying a vapor phase of a powder feedstock. By directing the plasma plume into the internal cavity of a component, a coating of the feedstock material may be formed on the surface of the internal cavity. In some examples, the width or cross-sectional area of the plasma plume may be reduced by the shape and position of the funnel to focus and direct the plasma plume into the internal cavity of the opening. For example, the outlet opening of the funnel may be aligned with the opening of the internal cavity so that the plasma plume exiting the funnel enters the internal cavity to coat the surface of the internal cavity. In some examples, the funnel may function to concentrate the plasma plume that enters the inlet of the funnel through an outlet of the funnel into the internal cavity, where the outlet of the funnel is smaller than the inlet of the funnel. The funnel may be used direct a larger volume of energetic gas carrying the feedstock material through a smaller opening in the internal cavity.

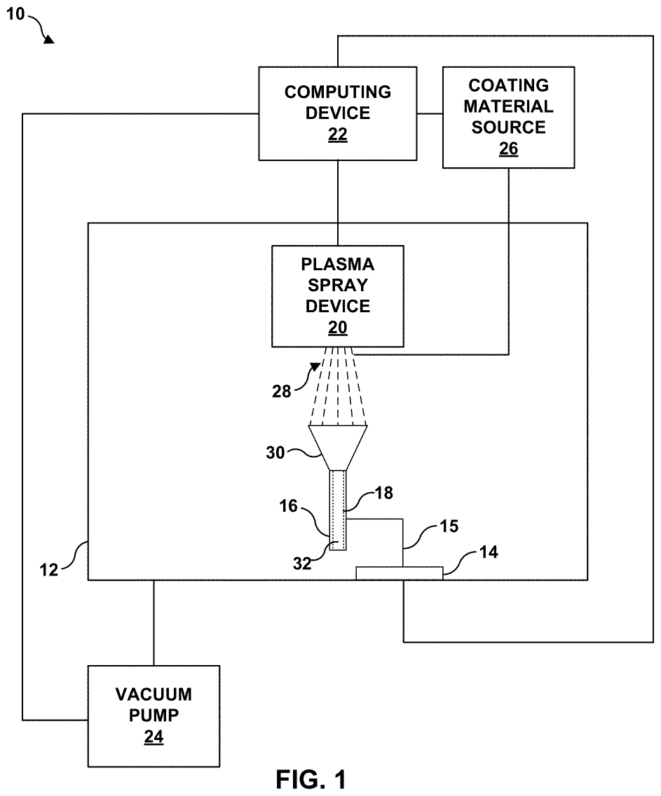

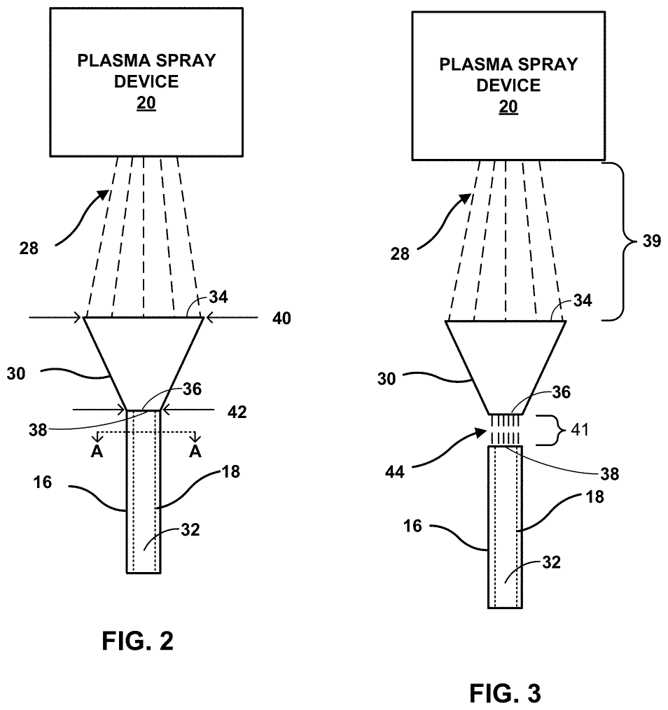

FIG. 1 is a conceptual and schematic diagram illustrating an example system 10 for forming an EBC or other coating using PS PVD in accordance with some examples the disclosures. FIGS. 2 and 3 are conceptual and schematic diagrams illustrating substrate 16, plasma spray device 20, and funnel 30 of system 10 of FIG. 1. FIG. 2 illustrates a magnified view of the arrangement of system 10 show in FIG. 1 in which funnel 30 is attached to or otherwise positioned directly adjacent to substrate 16. FIG. 3 illustrates another example arrangement of system 10 in which there is a gap 41 between funnel 30 and substrate 16.

As shown in FIG. 1, system 10 includes a vacuum chamber 12, a stage 14 enclosed in vacuum chamber 12, and plasma spray device 20. System 10 also includes a vacuum pump 24, a coating material source 26, and a computing device 22. Substrate 16 is disposed in enclosure 12 and includes an internal cavity 32 defined by inner surface 18 of substrate 16. System 10 also includes funnel 30 that is positioned adjacent to substrate 16 between substrate 16 and plasma spray device 20. Tool arm 15 attaches substrate 16 to stage 14.

Vacuum chamber 12 may substantially enclose (e.g., enclose or nearly enclose) stage 14, substrate 16, funnel 30, and plasma spray device 20. Vacuum chamber 12 is fluidically connected to at least one vacuum pump 24, which is operable to pump fluid (e.g., gases) from the interior of vacuum chamber 12 to establish a vacuum in vacuum chamber 12. In some examples, vacuum pump 24 may include multiple pumps or multiple stages of a pump, which together may evacuate vacuum chamber 12 to high vacuum. For example, vacuum pump 24 may include at least one of a scroll pump, a screw pump, a roots pump, a turbomolecular pump, or the like. As used herein, high vacuum may refer to pressures of less than about 10 torr (less than about 1.33 kilopascals (kPa)). In some examples, the pressure within vacuum chamber 12 during the PS-PVD technique may be between about 0.5 torr (about 66.7 pascals) and about 10 torr (about 1.33 kPa).

In some examples, during the evacuation process, vacuum chamber 12 may be backfilled with a substantially inert atmosphere (e.g., helium, argon, or the like), then the substantially inert gases removed during subsequent evacuation to the target pressure (e.g., high vacuum). In this way, the gas molecules remaining in vacuum chamber 12 under high vacuum may be substantially inert, e.g., to substrate 16 and EBC 18.

In some examples, tool arm 15 of stage 14 may be configured to selectively position and restrain substrate 16 in place relative to stage 14 during formation of a coating (not shown), e.g., on the surface 18 of internal cavity 32. In other examples, system 10 may omit tool arm 15 and substrate 16 may be placed directly on stage 14. In some examples, stage 14 is movable relative to plasma spray device 20. For example, stage 14 may be translatable and/or rotatable along at least one axis to position substrate 16 relative to plasma spray device 20. Similarly, in some examples, plasma spray device 20 may be movable relative to stage 14 to position plasma spray device 20 relative to substrate 16.

In some examples, funnel 30 may be attached to substrate 16 and substrate 16 may be attached to tool arm 15. In such cases, the movement of stage 14 may result in movement of funnel 30 and substrate 16. In other cases, funnel 30 may not be attached to substrate 16. For example, funnel 30 may be attached to another tool arm and stage that moves and positions funnel 30 independently of substrate 16 and/or plasma spray device 20. It is envisioned that system 10 may be configured such that substrate 16, funnel 30, and plasma spray device 20 may be moveable and/or fixed relative to each other to position substrate 16, funnel 30, and plasma spray device 20 in a manner that allows system 10 to operate to form a coating on surface 18 of internal cavity 16 of substrate 16 using funnel 30 as described herein.

Plasma spray device 20 includes a device used to generate a plasma plume 28 for use in the PS PVD technique. For example, plasma spray device 20 may include a plasma spray gun including a cathode and an anode (or nozzle) separated by a plasma gas channel. As the plasma gas flows through the plasma gas channel, a voltage may be applied between the cathode and anode to cause the plasma gas to form the plasma plume 28. In some examples, the coating material may be injected inside plasma spray device 20 such that the coating material flows through part of the plasma gas channel. In some examples, the coating material may be introduced to the plasma external to plasma spray device 20, as shown in FIG. 1. In some examples, the coating material may be a relatively fine powder (e.g., an average particle size of less than about 5 micrometers) to facilitate at least partial vaporization of the coating material by the plasma. In some examples, the relatively fine powder may be agglomerated into a composite powder that serves as the material fed to plasma spray device 20. The composite powder may have a particle size that is larger than the relatively fine powder.

Coating material source 26 may include at least one source of material which is injected into the plasma plume 28 generated by plasma spray device 20 and deposited in a layer to form a coating on substrate 16. In some examples, the material may be in powder form, and may be supplied by coating material source 26 carried by a fluid, such as air, an inert gas, or the like. In some examples, the material supplied by coating material source 26 may be referred to as the material feedstock or powder feedstock.

Computing device 22 may include, for example, a desktop computer, a laptop computer, a workstation, a server, a mainframe, a cloud computing system, or the like. Computing device 22 may include or may be one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some examples, the functionality of computing device 22 may be provided within dedicated hardware and/or software modules.

Computing device 22 is configured to control operation of system 10, including, for example, stage 14, plasma spray device 20, and/or vacuum pump 24. Computing device 22 may be communicatively coupled to at least one of stage 14, plasma spray device 20, and/or vacuum pump 24 using respective communication connections. Such connections may be wireless and/or wired connections.

Computing device 22 may be configured to control operation of stage 14 and/or plasma spray device 20 to position substrate 16 relative to plasma spray device 20. For example, as described above, computing device 22 may control plasma spray device 20 to translate and/or rotate along at least one axis to position substrate 16 relative to plasma spray device 20. In examples in which funnel 30 is attached to substrate 16, computing device 22 may likewise control operation of stage 14 and/or plasma spray device 20 to position funnel 30 relative to plasma spray device 20. In examples in which funnel 30 is independently moveable relative to plasma spray device 20 and substrate 16 (e.g., in cases in which funnel 30 is attached to a stage and tool arm similar to that of substrate 16), computing device 22 may be configured to control operation of stage 14, plasma spray device 20, and/or a device that controls the position of funnel 30 to position substrate 16 relative to plasma spray device 20 and funnel 30.

As described above, system 10 may be configured to perform a PS PVD technique to deposit a coating (not shown in FIG. 1) on surface 18 of internal cavity 32 of substrate 16. PS PVD is a flexible process that allows relatively easy adjustment of process parameters to result in coatings with different chemistry, microstructure, or both. In some examples, substrate 16 may include component of a high temperature mechanical system, such as a gas turbine engine. For example, substrate 16 may be part of a seal segment, a blade track, an airfoil, a blade, a vane, a combustion chamber liner, or the like. Substrate 16 may include inner walls 18 that define internal cavity 32, which may be accessed through opening 38. In some examples, substrate 16 may have more than one opening to internal cavity 32. For example, substrate 16 may take the form of a tubular substrate (e.g., with a circular or rectangular cross-section) that has an opening on both ends of open cavity 32. In other examples, substrate 16 may only have a single opening 38 to access internal cavity 18.

In some examples, substrate may include a ceramic or a CMC. Example ceramic materials may include, for example, silicon carbide (SiC), silicon nitride (Si₃N₄), alumina (Al₂O₃), aluminosilicate, silica (SiO₂), transition metal carbides and silicides (e.g. WC, Mo₂C, TiC, MoSi₂, NbSi₂, TiSi₂), or the like. In some examples, substrate 16 additionally may include silicon metal, carbon, or the like. In some examples, substrate 16 may include mixtures of two or more of SiC, Si₃N₄, Al₂O₃, aluminosilicate, silica, silicon metal, carbon, or the like.

In examples in which substrate 16 includes a CMC, substrate 16 includes a matrix material and a reinforcement material. The matrix material includes a ceramic material, such as, for example, silicon metal, SiC, or other ceramics described herein. The CMC further includes a continuous or discontinuous reinforcement material. For example, the reinforcement material may include discontinuous whiskers, platelets, fibers, or particulates. As other examples, the reinforcement material may include a continuous monofilament or multifilament weave. In some examples, the reinforcement material may include SiC, C, other ceramic materials described herein, or the like. In some examples, substrate 16 includes a SiC—SiC ceramic matrix composite.

Computing device 22 may be configured to control operation of system 10 (e.g., vacuum pump 24, plasma spray device 20, and coating material source 26) to perform PS PVD to deposit a coating (not shown in FIGS. 1-3) onto surface 18 of open cavity 32. Example coatings include EBCs and TBCs. PS PVD may operate at low operating pressures, such as between about 0.5 torr and about 10 torr. In some examples, the temperatures of the plasma may be greater than about 6000 K, which may vaporize the coating material. Because the vaporized coating material is carried by a gas stream, PS PVD may allow deposition multilayer, multi-microstructure coating on surfaces of substrate 16 that are not in line-of-sight relationship with plasma spray device 20. Further, a deposition rate (e.g., thickness of coating deposited per unit time) may be greater for PS PVD than for other vapor phase deposition processes, such as chemical vapor deposition or physical vapor deposition, which may result in PS PVD being a more economical coating technique.

As shown in FIG. 1, during a PS PVD process, funnel 30 may be positioned between plasma spray device 20 and substrate 16. Funnel 30 may be positioned relative plasma spray device 20 such that plasma plume 28 generated by plasma spray device 20 enters inlet 34 of funnel 30 and exits outlet 36 of funnel 30. Funnel 30 may be positioned relative to substrate 16 such that the portion of plasma plume 28 entering inlet 34 of funnel 30 exits out of outlet 36 into opening 38 of internal cavity 18. The portion of plasma plume 28 that exits out of outlet 36 into opening 38 of internal cavity 18 may form a coating of the vaporized material from coating material source 26 on surface 18 of open cavity 32.

Outlet 34 of funnel 30 has first width 40 and inlet 36 of funnel 30 has second width 42 that is less than first width 40. In some examples, funnel 30 is tapered between outlet 34 and inlet 36 to allow for a gradual change in width between outlet 34 and inlet 36. In other examples, rather than a continuous and gradual transition, the transition may be a series of discrete changes, e.g., in cases in which funnel 30 decreases in width in a step-wise fashion. Width 42 of outlet 36 of funnel 30 may be substantially the same size and shape of opening 38 of substrate 16.

During operation of PS PVD system 10, the cross-section of plasma plume 28 that enters inlet 34 of funnel 30 may be greater than the cross-section of opening 38 of internal cavity 32. This cross-section of the plasma plume 28 may be substantially orthogonal to the longitudinal axis of plume 28, substantially orthogonal to the direction at which plasma plume extends out of plasma spray device 20, and/or along substantially the same plane as the cross-section of opening 38 of internal cavity 32. Funnel 30 may act to direct and concentrate the volume of plasma plume 28 entering inlet 34 of funnel into the relatively smaller opening 38 of substrate 16. In this manner, PS PVD system 10 may be employed to form a coating on surface 18 of internal cavity 32 of substrate 16 even though the size of plasma plume 28 generated by plasma spray device 20 is greater than the size of opening 38 to internal cavity 32.

Outlet 36 of funnel 30 may be substantially aligned with (e.g., aligned with or nearly aligned with) opening 38 of internal cavity 32 such that the plasma plume exiting outlet 36 enters internal cavity 32. In the example of FIG. 2, funnel 30 is positioned such that outlet 36 of funnel 30 is directly adjacent to opening 38 of internal cavity 32. In some examples, outlet 36 of funnel 30 directly abuts or contacts opening 38 of internal cavity 32. In other examples, outlet 36 of funnel 30 and opening 38 may be in a nested configuration, e.g., in which a portion of funnel 30 sits inside opening 38 or vice versa. Conversely, in the example of FIG. 3, there is a gap 41 between opening 38 of internal cavity 32 and outlet 36 of funnel 30.

During operation, plasma plume portion 44 that exits out of outlet 36 is directed into opening 38 of internal cavity. Plasma plume portion 44 may have a cross-section or width that is less than that of plasma plume 28 that enters inlet 34 of funnel 30.

Funnel 30 may be formed of any suitable composition. In some examples, funnel 30 may be made of a high temperature superalloy, such as a high-temperature nickel- or cobalt-based superalloy, although other materials are contemplated. An example high temperature superalloy is INCONEL® 718 (between 50 and 55 wt. % nickel (plus cobalt), between 17 and 21 wt. % chromium, between 4.75 and 5.5 wt. % niobium (plus tantalum), between 2.8 and 3.3 wt. % molybdenum, between 0.65 and 1.15 wt. % titanium, between 0.2 and 0.8 wt. % aluminum, a maximum of 1 wt. % cobalt, a maximum of 0.08 wt. % carbon, a maximum of 0.35 wt. % manganese, a maximum of 0.35 wt. % silicon, a maximum of 0.015 wt. % phosphorus, a maximum of 0.015 wt. % sulfur, a maximum of 0.006 wt. % boron, a maximum of 0.3 wt. % copper, and a balance iron), available from Special Metals Corporation, New Hartford, N.Y.

Gap 39 may also exist between inlet 34 of funnel 30 and plasma spray device 20. Gap 39 may be between the position at which plasma plume 28 is first generated by plasma spray device 20 and inlet 34 of funnel 30. In some examples, gap 39 may be between the nozzle of a spray gun used by spray device 20 to generate plasma plume 28 and inlet 34 of funnel 30.

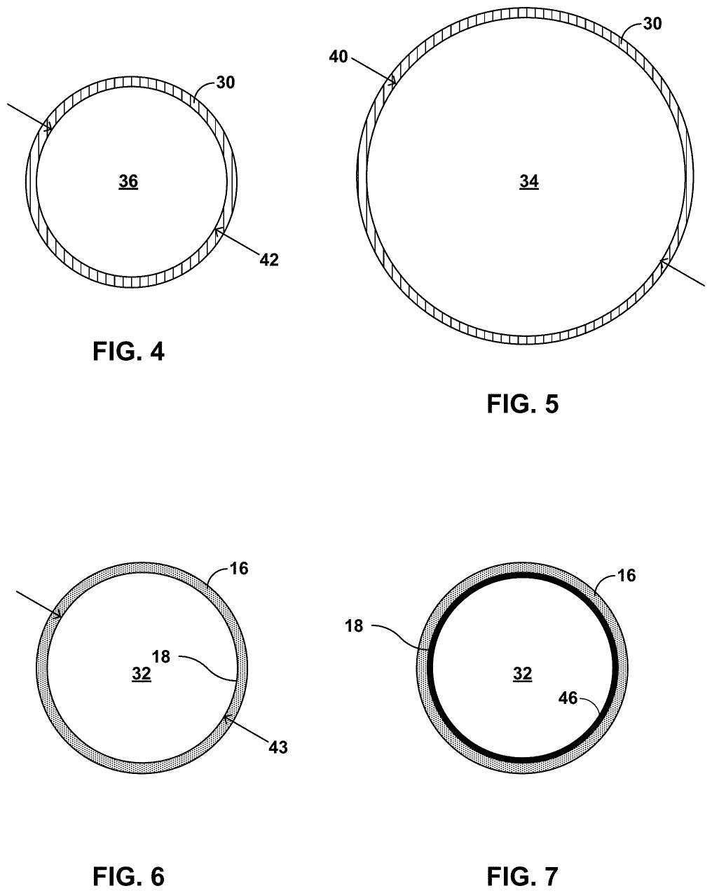

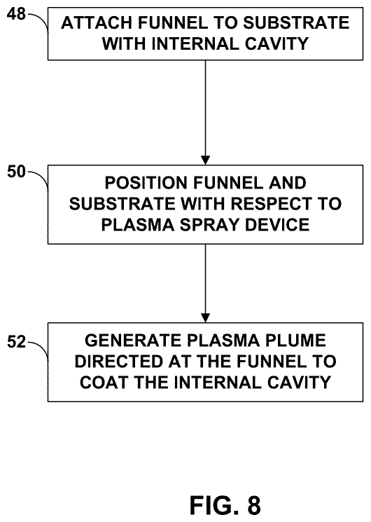

FIG. 4 is a conceptual diagram illustrating a plan view of outlet opening 36 of funnel 30 from the “bottom” of funnel 30 in the orientation show in FIG. 2. FIG. 5 is a conceptual diagram illustrating a plan view of inlet opening 34 of funnel 30 from the “top” of funnel 30 in the orientation show in FIG. 2. Reference to “top” and “bottom” herein is for ease of description only and is not intended to limit the orientation of PS PVD system 10 in operation.

As shown in FIGS. 4 and 5, outlet 36 and inlet 34 of funnel 30 may have substantially the same cross-sectional shape. In the example of FIGS. 4 and 5, the cross-sectional shape is substantially circular although other geometries are contemplated such as rectangular, oval, diamond, triangular, and the like. In some examples, the cross-sectional shape of inlet 34 may be different than the cross-sectional shape of outlet 36. The cross-sectional area of inlet 34 may be greater than the cross-sectional area of outlet 36 of funnel 30. In this manner, funnel 30 may be configured to direct and focus the plasma plume 28 entering inlet 34 into a smaller area such as opening 38 when exiting out of outlet 36 of funnel.

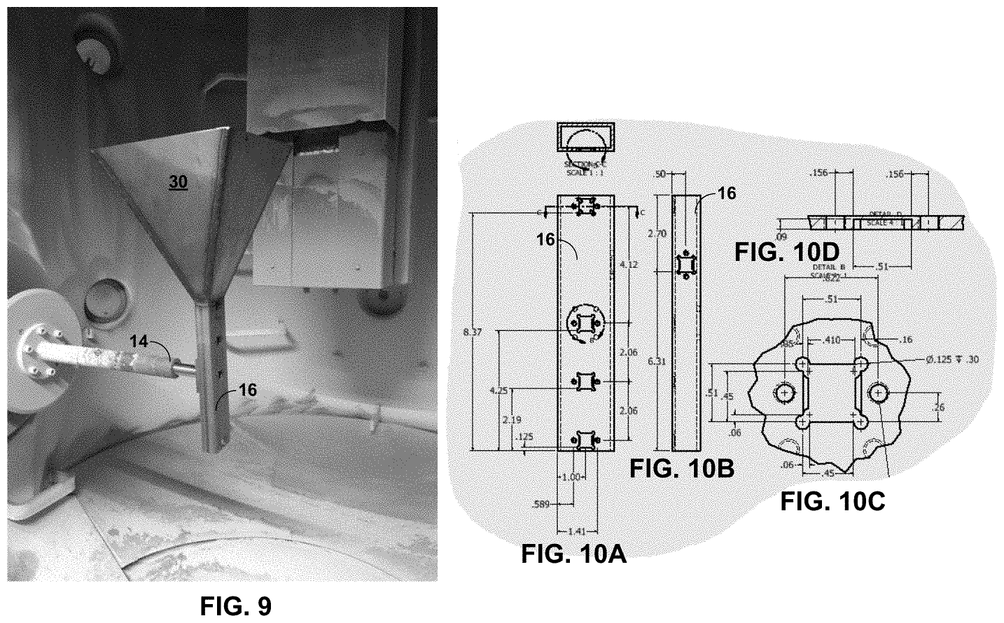

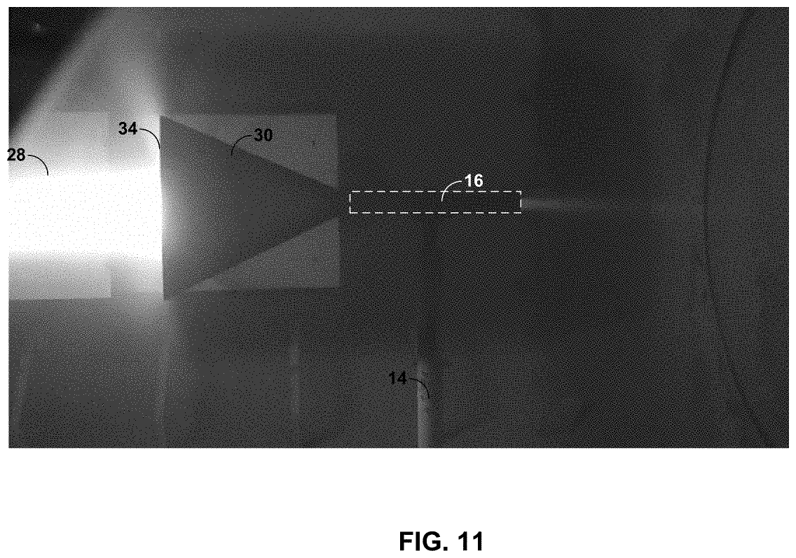

FIG. 6 is a conceptual diagram illustrating a cross sectional view of substrate 16 taken along cross-section A-A shown in FIG. 2 prior to the formation of a coating on the surface 18 of internal cavity 32. FIG. 7 is a conceptual diagram illustrating a cross sectional view of substrate 16 taken along cross-section A-A shown in FIG. 2 after the formation of coating 46 on the surface 18 of internal cavity 32.

As shown, internal cavity 32 of substrate 16 may have a substantially circular cross-section having width 42 as the diameter. The size and shape of the cross-section of substrate 16 may be the same or substantially similar to that of the size and shape of opening 38 to internal cavity 32. The size and shape of the cross-section of substrate 16 may be the same or substantially similar to the size and shape of outlet 36 of funnel 30. As noted above, in some examples, when outlet 36 of funnel 30 and opening 38 both have circular cross-sections, width 43 of substrate 16 may be approximately the same or the same as the width 42 of outlet 36 of funnel 30. In some examples, width 43 of substrate 16 may be different then width 42 of outlet 36 of funnel 30, e.g., to allow outlet 36 of funnel 30 to be nested within opening 38 of substrate 16, or vice versa.

Coating 46 may be formed by operating a system such as system 10 of FIG. 1 to perform a PS PVD process. As shown in FIG. 7, coating 46 is formed on surface 18 of internal cavity 32 of substrate 16. As used herein, “formed on” and “on” mean a layer or coating that is formed on top of another layer or coating, and encompasses both a first layer or coating formed immediately adjacent a second layer or coating and a first layer or coating formed on top of a second layer or coating with one or more intermediate layers or coatings present between the first and second layers or coatings. In contrast, “formed directly on” and “directly on” denote a layer or coating that is formed immediately adjacent another layer or coating, e.g., there are no intermediate layers or coatings. In some examples, as shown in FIG. 7, coating 46 may be directly on substrate 16. In other examples, one or more coatings or layers of coatings may be between coating 46 and substrate 16.

The composition of coating 46 may be controlled by the composition of coating material source 26. Coating 46 may take the form of an EBC and may help protect underlying substrate 16 from chemical species present in the environment the coated substrate is used, such as, e.g., water vapor, calcia-magnesia-alumina-silicate (CMAS; a contaminant that may be present in intake gases of gas turbine engines), or the like. Additionally, in some examples, coating 46 may also protect substrate 16 and provide for other functions besides that of an EBC, e.g., by functioning as a thermal barrier coating (TBC), abradable coating, erosion resistant coating, and/or the like.

Coating 46 may include at least one of a rare-earth oxide, a rare-earth silicate, an aluminosilicate, or an alkaline earth aluminosilicate. For example, coating 46 may include mullite, barium strontium aluminosilicate (BSAS), barium aluminosilicate (BAS), strontium aluminosilicate (SAS), at least one rare-earth oxide, at least one rare-earth monosilicate (RE₂SiO₅, where RE is a rare-earth element), at least one rare-earth disilicate (RE₂Si₂O₇, where RE is a rare-earth element), or combinations thereof. The rare-earth element in the at least one rare-earth oxide, the at least one rare-earth monosilicate, or the at least one rare-earth disilicate may include at least one of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), or scandium (Sc). For example, coating 46 may include silicon (Si), ytterbium disilicate (Yb₂Si₂O₇), ytterbium monosilicate (Yb₂SiO₅), yttrium disilicate (Y₂Si₂O₇), ytterium monosilicate (Y₂SiO₅), and/or mullite.

Coating 46 may be formed to have any suitable thickness. For example, coating 46 may be about 0.003 inches (about 76.2 micrometers) to about 0.020 inches (about 508 micrometers). In other examples, layer 18 may have a different thickness.

In some examples, a coating material provided by coating material source 26 may include additional and optional constituents of coating 46. For example, the additional and optional constituents coating 46 may include at least one rare earth disilicate may include BSAS, alumina, an alkali metal oxide, an alkaline earth metal oxide, TiO₂, Ta₂O₅, HfSiO₄, or the like. The additive may be added to the layer to modify one or more desired properties of the layer. For example, the additive components may increase or decrease the modulus of the layer, may decrease the reaction rate of the layer with calcia-magnesia-alumina-silicate (CMAS; a contaminant that may be present in intake gases of gas turbine engines), may modify the viscosity of the reaction product from the reaction of CMAS and constituent(s) of the layer, may increase adhesion of the layer to an adjacent layer, may increase the chemical stability of the layer, may decrease the steam oxidation rate, or the like.

Although coating 46 is shown as a single layer, in other examples, coating 46 may include multiple layers of the same or different compositions. In some examples, coating 46 may include an optional bond layer between coating 46 and surface 18 and may increase the adhesion of coating 46 to surface 18. In some examples, the bond layer may include silicon and take the form of a silicon bond layer. The bond layer may be in direct contact with substrate 16 and coating 46. In some examples, the bond layer has a thickness of about 0.001 inch (about 25.4 micrometers) to about 0.020 inch (about 254 micrometers), although other thicknesses are contemplated.

In examples in which substrate 16 includes a ceramic or CMC, the bond layer may include a ceramic or another material that is compatible with the material from which substrate 16 is formed. For example, the bond layer may include mullite (aluminum silicate, Al₆Si₂O₁₃), silicon metal or alloy, silica, a silicide, or the like. The bond layer may further include other elements, such as a rare earth silicate including a silicate of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), and/or scandium (Sc).

The composition of the bond layer may be selected based on the chemical composition and/or phase constitution of substrate 16 and the overlying layer (e.g., coating 46). For example, if substrate 16 includes a ceramic or a CMC, the bond layer may include silicon metal or alloy or a ceramic, such as, for example, mullite.

In some cases, bond coat 16 may include multiple layers. For example, in some examples in which substrate 16 includes a CMC including silicon carbide, bond coat 16 may include a layer of silicon on substrate 16 and a layer of mullite, a rare earth silicate, or a mullite/rare earth silicate dual layer on the layer of silicon. In some examples, a bond coat 16 including multiple layers may provide multiple functions of bond coat 16, such as, for example, adhesion of substrate 16 to an overlying layer (e.g., EBC layer 18 of FIG. 1), chemical compatibility of bond coat 16 with each of substrate 16 and the overlying layer, a better coefficient of thermal expansion match of adjacent layers, or the like. In some examples, system 10 (FIG. 1) may be used to deposit the optional bond coat layer on surface 18 of substrate 16 using PS PVD.

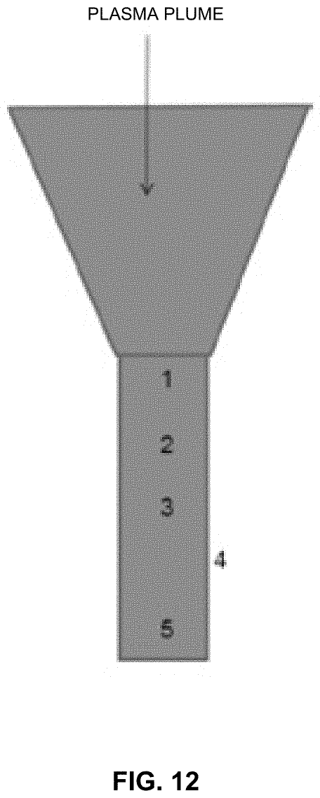

FIG. 8 is a flow diagram illustrating an example technique for forming a coating on the surface of an internal cavity using, e.g., the system of FIG. 1, using PS PVD. For example, system 10 may deposit coating 46 (FIG. 7) on surface 18 of internal cavity 32 of substrate 16 by a PS PVD process using the technique of FIG. 8. As shown in FIG. 8, funnel 30 may be attached to substrate 16, where substrate includes internal cavity 32 (48). Funnel 30 may be attached to substrate 16 such that outlet 36 of funnel 30 aligns with opening 38 of internal cavity 32. As described herein, the alignment of outlet 36 of funnel 30 with opening 38 of internal cavity 32 and shape of funnel 30 allows for plasma plume 20 that enters inlet 34 to be concentrated and directed into internal cavity 32 via opening 38.

In some examples, funnel 30 may be attached directly to substrate 16, e.g., by one or more bolts or other mechanical fasteners. Those fasteners may be removeable to allow funnel 30 to be removed from substrate 16 after coating 46 has been formed. In other examples, funnel 30 may not be attached directly to substrate 16. For example, system 10 may include one or more tool arms that are attached to funnel 30 and one or more tool arms that are attached to substrate 16. The tool arms may be moveable to position funnel 30 relative to substrate 16 as desired. In some examples, as described above, outlet 36 of funnel 30 may be positioned directly adjacent to opening 38 of internal cavity 32 of substrate 16. IN other examples, funnel 30 may be positioned relative to substrate 16 such that gap 41 is between outlet 36 and opening 38.

Funnel 30 and substrate 16 may then be positioned relative to plasma spray device 20 (50). For example, funnel 30 and substrate 16 may be positioned relative to plasma spray device within vacuum chamber 12 such that plasma plume 28 generated by plasma spray device 20 enters outlet 34 of funnel and exits funnel via outlet 36 into internal cavity 32 of substrate 16 via opening 36. Computing device 22 may control stage 15 and arm 15 to position of funnel 30 and substrate 16 relative plasma spray device 20 as desired. As described above, funnel 30 may be positioned such that gap 39 exists between the point of plasma spray device 20 that plasma plume is generated and inlet 34 of funnel. Computing device 22 may control plasma spray device 20 and funnel 30 such that gap 39 has the desired distance. System 10 may be configured such that some or all of plasma spray device 20, funnel 30, and substrate 16 are moveable relative to each other.

Once funnel 30, substrate 16, and plasma spray device 20 are all positioned relative to each other as desired, computing device 22 may control plasma spray device 20 to generate plasma plume 28 toward inlet 34 of funnel 30. Funnel 30 may concentrate and direct the volume of plasma plume 28 that enter inlet 34 through outlet 36 into opening 36 of substrate 16. The vapor phase material from coating material source 20 carried by plasma plume 28 that enters opening 38 may be deposited on surface 18 of internal cavity 32 to form coating 46.

Computing device 20 may control the voltage applied between the anode and cathode of plasma spray device 20, a flow rate of powder into plasma spray device 20 or the plasma plume, a flow rate of working gas into plasma spray device 20, a standoff distance between plasma spray device 20 and inlet 34 of funnel 30, or the like, during the PS PVD process to control one or more properties of the deposited coating 46.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

### Example

An experiment was performed to determine the ability of a PS PVD coating process to coat non-line of sight surfaces within an internal cavity of a component using a funnel, as described below. However, the disclosure is not limited by the experiment or the corresponding description.

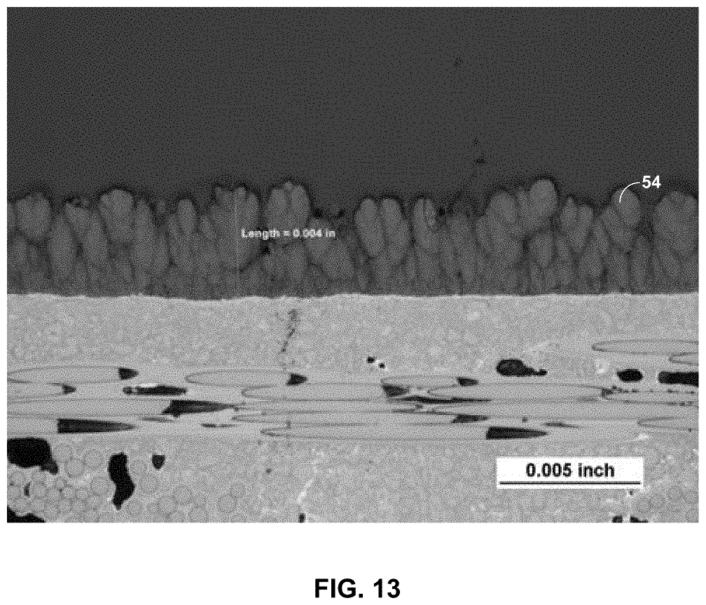

FIG. 9 is a photograph of an example funnel 30 of a PS PVD system and substrate 16 having an internal cavity. For the experiment, special fixture was made from a tube, with SiC/SiC CMC samples exposed inner surface of the tube. In particular, substrate 16 took the form of a hollow tube having a substantially rectangular cross-section and having openings on either end. The funnel 30 also had a rectangular cross-section.

For the design of the PS PVD coating system shown in FIG. 9, the smaller opening of funnel 30 was attached to and located at the end of tubular substrate 16 to help divert high energy plasma gas containing coating in the vapor phase through the tubular substrate 16. Tool arm 14 was attached to tubular substrate 16 and was used to control the position of tubular substrate 16 and funnel 30.

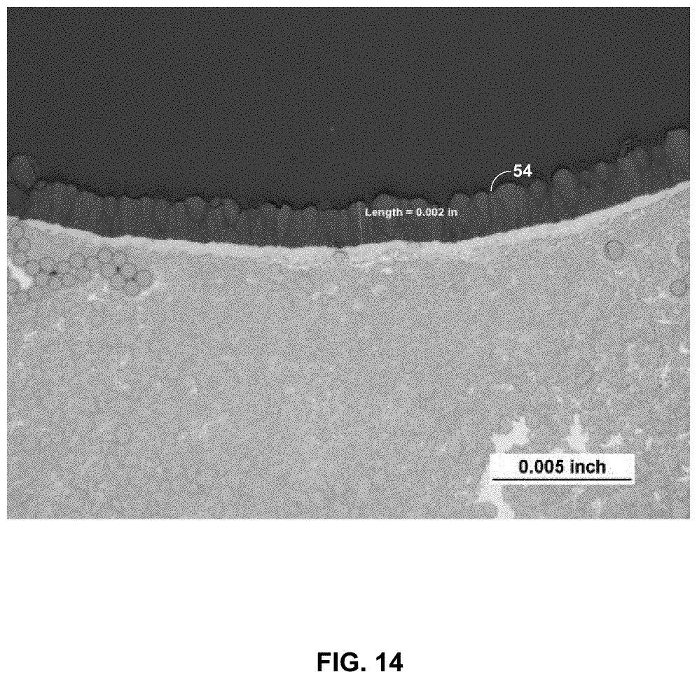

FIGS. 10A-10D are schematic diagrams illustrating the dimensions of tubular substrate 16, with the labelled dimensions in units of inches. FIGS. 10A and 10B illustrate substrate 16 from two sides. FIGS. 10C and 10D illustrate zoomed in views of circle B and section C-C of FIG. 10A, respectively. The tubular substrate 16 was approximately 8 inches long with SiC/SiC CMC samples dispersed along the length of the tubular substrate 16.

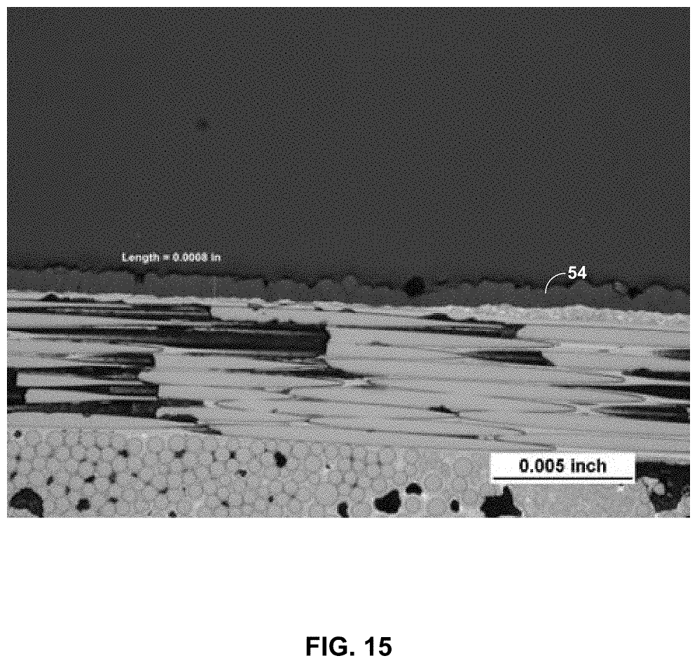

FIG. 11 is a photograph illustrating PS PVD system including the funnel and tubular substrate shown in FIG. 9 during operation of the PS PVD system. Tool arm 14 held the tubular substrate 16 and attached funnel 30 within the plasma plume 28 generated by the PS PVD system. As shown, the plasma plume 28 generated by the PS PVD system entered inlet 34 of the funnel 30, entered the open cavity of tubular substrate via the outlet of the funnel 30, and exited the opposite open end of the tubular substrate 16. The funnel 30 directed and concentrated the wider plasma plume into the smaller internal cavity of the tubular substrate 16 to coat SiC/SiC CMC samples with a ytterbium disilicate coating.

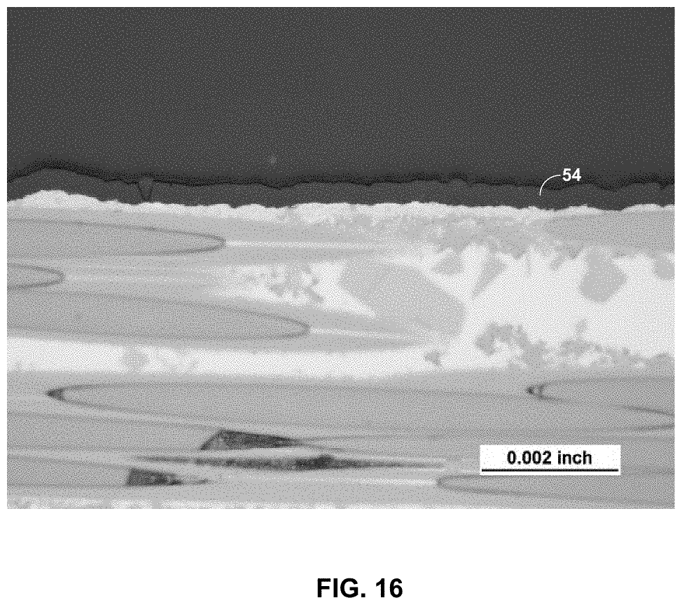

FIG. 12 is a conceptual diagram illustrating the funnel and tubular substrate of FIG. 9 with reference markers 1-5 along the length of the tubular substrate. The reference markers indicate the position of the various CMC samples within the tubular substrate 16.

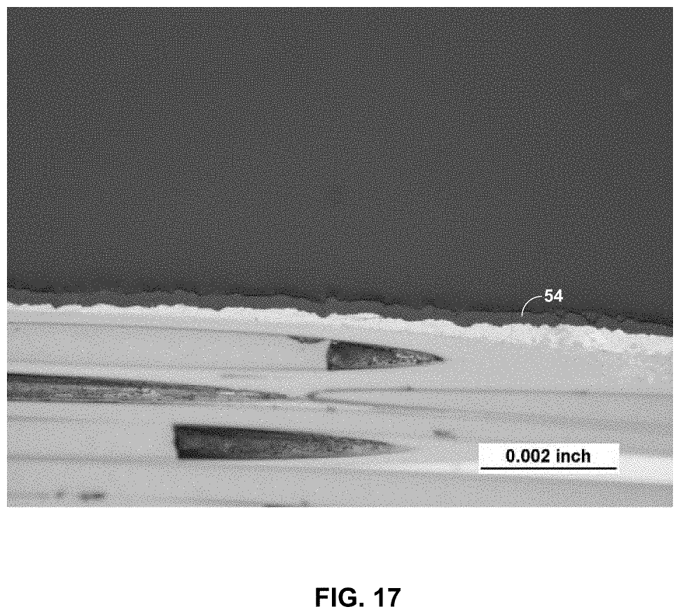

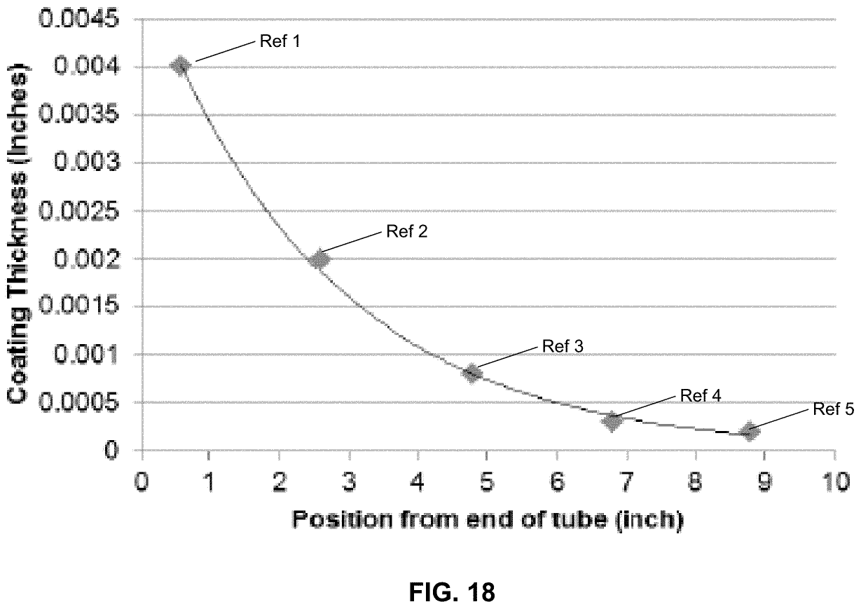

FIGS. 13-17 are cross-sectional micrographs of the example coating 54 deposited using PS PVD at reference points 1-5, respectively, indicated in FIG. 12. FIG. 18 is a plot of coating thickness versus position within the internal cavity for the tubular substrate 16 shown in FIG. 9. As shown in FIGS. 13-18, at the reference point closest to the funnel outlet (reference point 1), the coating shows a columnar structure, and the coating becomes thinner and denser moving towards the opposite end of the funnel from reference point 1 to reference point 5.

Various examples have been described. These and other examples are within the scope of the following claims.

What is claimed is:

1. A plasma spray physical vapor deposition system comprising:
a vacuum pump;
a vacuum chamber;
a coating material source;
a plasma spray device configured to generate a plasma plume including vaporized coating material; and
a funnel having an inlet opening and an outlet opening smaller than the inlet opening, wherein the funnel is configured and positioned to receive the plasma plume through the inlet opening and direct the plasma plume out of the outlet opening.

2. The system of claim 1, wherein the funnel is configured to reduce a width of the plasma plume from the inlet opening to outlet opening.

3. The system of claim 1, wherein the funnel is tapered between the inlet opening and the outlet opening.

4. The system of claim 1, further comprising a component having an internal cavity and an internal cavity opening, wherein the funnel is configured and positioned to be aligned with the component defining the internal cavity such that the outlet opening is substantially aligned with the internal cavity opening.

5. The system of claim 4, wherein, when the outlet opening is substantially aligned with the internal cavity opening, the plasma plume directed out of the outlet opening is configured to enter the internal cavity through the internal cavity opening to form a coating on a surface of the internal cavity of the component.

6. The system of claim 4, wherein the component is configured to be attached to the funnel, and wherein the outlet opening is substantially aligned with the internal cavity opening when the component is attached to the funnel.

7. The system of claim 4, further comprising a tooling configured to hold at least one of the funnel or the component to substantially align the outlet opening with the internal cavity opening.

8. The system of claim 4, wherein the outlet opening has substantially a same size and shape of the internal cavity opening.

9. The system of claim 1, wherein the funnel has a pyramidal shape.

10. The system of claim 1, wherein the plasma spray device includes a nozzle separate from the funnel.

11. A method for forming a coating using plasma spray physical vapor deposition, the method comprising:
generating a plasma plume via a plasma spray device, wherein the plasma plume includes vaporized coating material, and
positioning a funnel having an inlet opening and a smaller outlet opening relative to the plasma spray device such that the plasma plume enters through the inlet opening and is directed by the funnel out of the outlet opening.

12. The method of claim 11, wherein the funnel is configured to reduce a width of the plasma plume from the inlet opening to outlet opening.

13. The method of claim 11, wherein the funnel is tapered between the inlet opening and the outlet opening.

14. The method of claim 11, further comprising positioning the outlet opening of the funnel to be substantially aligned with an internal cavity opening of a component having an internal cavity.

15. The method of claim 14, wherein, when the outlet opening is substantially aligned with the internal cavity opening, the plasma plume directed out of the outlet opening is configured to enter the internal cavity through the internal cavity opening to form a coating on a surface of the internal cavity of the component.

16. The method of claim 14, further comprising attaching the component to the funnel, wherein the outlet opening is substantially aligned with the internal cavity opening when the component is attached to the funnel.

17. The method of claim 14, further comprising coupling at least one of the funnel or the component to a tooling configured to hold at least one of the funnel or the component to substantially align the outlet opening with the internal cavity opening.

18. The method of claim 14, wherein the outlet opening has substantially a same size and shape of the internal cavity opening.

19. The method of claim 14, wherein the funnel has a pyramidal shape.

20. The method of claim 11, wherein the plasma spray device includes a nozzle separate from the funnel.
